(19) United States
(12) Patent Application Publication
(10) Pub. No.: US 2006/0144650 A1
(43) Pub. Date: Jul. 6, 2006

(54) Bicycle brake shoe

(76) Inventor: A. P. Lin, Chang Hwa City (TW)

Correspondence Address: CHARLES E. BAXLEY, ESQ., 90 JOHN STREET, THIRD FLOOR, NEW YORK, NY, 10038, US

(21) Appl. No.: 11/031,593

(22) Filed: Jan. 6, 2005

(51) Int. Cl. B62L 1/02

(52) U.S. Cl. 188/24.12; 188/251 A

(57) ABSTRACT

Bicycle brake shoes are provided for a bicycle braking device. The brake shoes are pressed into contact with a bicycle wheel rim to apply a braking force thereto. The brake shoes are coupled to the bicycle braking device by brake shoe holders. Each brake shoe includes an attachment portion coupled to the brake shoe holder and a rim contacting portion for contacting the side braking surface of the rim. The brake shoes are formed from a polymer that is obtained by cross-linking SBR with peroxide of adhesive or sulfur. The brake shoe is elongated in the rotation direction of the wheel rim and has a braking surface opposite to the braked surface of the rim.

### BACKGROUND OF THE INVENTION

1. Field of the Invention

The present invention relates to brake shoes are formed from a polymer that is obtained by cross-linking SBR with peroxide of adhesive or sulfur, so that said bicycle brake shoe does not excessively wear the rim while maintaining good performance in wet conditions.

2. Description of the Prior Arts

There are several types of bicycle braking devices on the current market. The types of bicycle braking devices include rim brakes and caliper brake, and the caliper brakes generally includes: a cantilever type, a side pull type, a center pull type.

All these prior art bicycle brakes are equipped with brake shoes typically molded from a rubber that is cross-linked with sulfur. The braking surfaces of the bicycle rim maybe hard and shiny surfaces that have been anodized, or the braking surface can be been ground and then polished to form a bicycle rim with softer braking surfaces. In the case of the anodized rim, the braking surfaces are hard and shiny which provides good braking performance in dry conditions, but poor braking performance in wet conditions. In the case of ground and polished braking surfaces, the conventional rubber brake shoes provide good braking performance in dry conditions, and better braking performance in wet conditions than hard and shiny braking surfaces with an anodized finish.

Attempts have been made to improve braking performance, especially in wet conditions, by manufacturing rubber brake shoes with refractory fillers. For example, rubber brake shoes have been manufactured with alumina (Al₂O₃). While such improved rubber brake shoes provide good wet and dry performance, such brake shoes with alumina cause too much wear of soft braking surfaces in the ground and polished types of rims. The trend in the bicycle industry is to produce more and more rims that have ground and polished braking surfaces. Since these braking surfaces are softer than the braking surfaces of the anodized rim, the alumina-improved brake shoes should not be used because of the excessive amount of wear on these types of rims.

The present invention has arisen to mitigate and/or obviate the afore-described disadvantages.

### SUMMARY OF THE INVENTION

One object of the present invention is to provide bicycle brake shoes that have improved braking performance in wet conditions.

Another object of the present invention is to provide bicycle brake shoes that do not excessively wear the rim during deceleration or stopping of the rim by the bicycle brake shoes braking while maintaining good performance in wet conditions.

The foregoing objects can be further attained by providing a bicycle brake shoe comprising a rim contacting portion with a braking surface formed from a polymer that is obtained by cross-linking Styrene butadiene rubber (SBR) with peroxide of adhesive (PO), and the polymer is further added with predetermined superaddition.

The foregoing objects can be further attained by providing a bicycle brake shoe comprising a rim contacting portion with a braking surface formed from a polymer that is obtained by cross-linking Styrene butadiene rubber (SBR) with sulfur (S).

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows bicycle brake shoes in accordance with the present invention is installed on the front fork of a bicycle;

FIG. 2 is perspective view of the bicycle brake shoes in accordance with the present invention;

FIG. 3 shows the brake arm of bicycle braking device in accordance with the present invention;

FIG. 4 is an operational view of the bicycle brake shoes in accordance with the present invention;

FIG. 5 is a perspective view of the bicycle brake shoes in accordance with the present invention;

FIG. 6 is an exploded view of the bicycle brake shoes in accordance with the present invention;

FIG. 7 is a perspective view of a bicycle brake shoe in accordance with another embodiment of the present invention;

FIG. 8 is a perspective view of a bicycle brake shoe in accordance with yet another embodiment of the present invention.

### DETAILED DESCRIPTION OF THE PREFERRED EMBODIMENTS

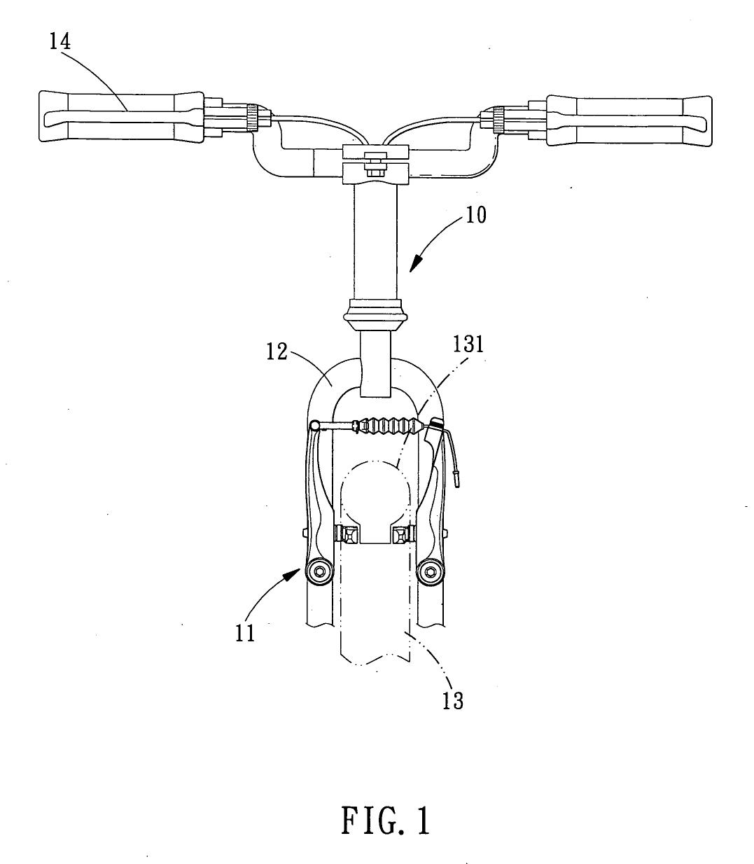

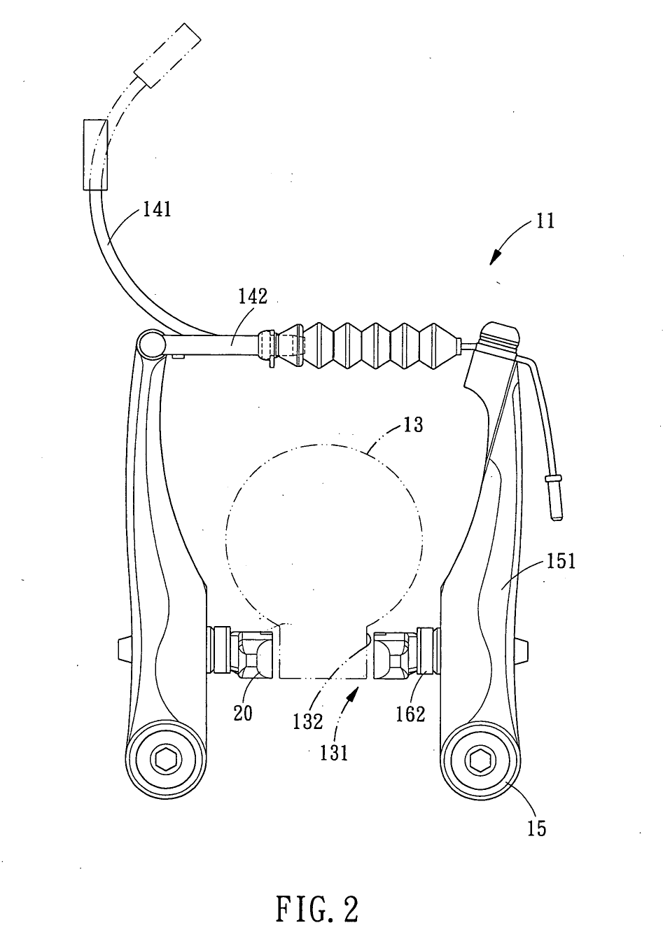

Referring initially to FIGS. 1 and 2, a front portion of a bicycle 10 is illustrated having a bicycle braking device 11 with a pair of brake shoes 20 according to the present invention. Bicycles and their various components are well-known in the prior art, and thus, bicycle 10 and its various components will not be discussed or illustrated in detail herein, except for the components of bicycle 10 which relate to the braking device 11 in accordance with the present invention. In other words, only bicycle braking device 11 will be discussed and illustrated in detail herein.

As seen in FIG. 1, the front braking device 11 is illustrated as being coupled to front fork 12 of bicycle 10 in a relatively conventional manner. Of course, it will be apparent to those skilled in the art from this disclosure that another braking device 11 is preferably coupled to the rear fork of bicycle 10 in a conventional manner.

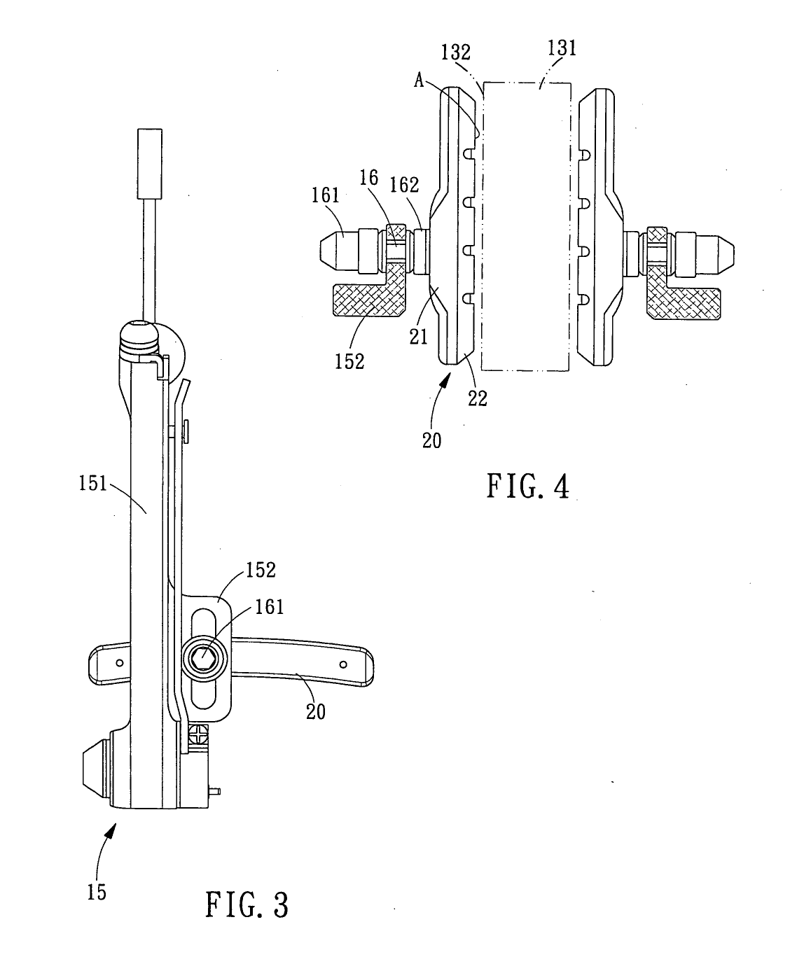

As shown in FIGS. 2 and 3, the front braking device 11 is a “cantilever type” of braking device. Of course, it will also be apparent to those skilled in the art from this disclosure that other types of bicycle braking devices that can utilize the brake shoes 20 of the present invention, as needed and/or desired.

Basically, braking device 11 is coupled to the front fork 12 of the bicycle 10 such that it can move between a release position and a brake position.

In the release position, the brake shoes 20 of the braking device 11 do not engage the rim 20 so that the wheel 13 is free to rotate.

In the brake position, the brake shoes 20 of the braking device 11 are pivoted such that the bicycle brake shoes 20 grip the braking surfaces 132 of the rim 131 to decelerate or stop rotation of the wheel 13.

In particular, the rider will operate the brake operating device 14 which in turn will pull cable 141 to cause the brake shoes 20 of the braking device 11 to engage the braking surfaces 132 of the rim 131 of the wheel 13. Since most braking devices are well known to those skilled in the art, the braking device 11 will only be briefly discussed and illustrated herein to the extent needed to understand the present invention.

Basically, each braking device 11 has a pair of brake mechanisms 15 that are pivotally coupled to front fork 12. Each of the braking mechanisms 15 have a brake arm 151, and a pair of brake shoe holders 152 to which the brake shoes 20 are secured in a conventional manner. A link 142 and one end of cable 141 interconnect the upper ends of brake arms 151 such that the brake mechanisms 15 pivot together in a conventional manner.

The brake shoe holders 152 are coupled to the brake arms 151 by a center post 16 and a nut 161. In operation, when the rider operates the brake lever of the brake operating device 14, the inner wire of the cable 141 is pulled within the outer casing of the cable 141 so that the upper portions of the brake arms 151 are pulled inwardly. Thereafter, the friction pads 20 on the brake shoe holders 152 and pad supports 162 are pressed against the side surfaces of the rim 131, thus causing a braking action to be performed.

Once the rider releases the brake lever of the brake operating device 14, the brake wire of the cable 141 is relaxed so that the coil springs within the brake arm cause the brake arms 151 to pivot in the opening direction. As a result, the tip ends of the brake shoes 20 (or so-called friction pads) on the brake shoe holders 152 are withdrawn from the side surfaces of rim 131 so that the braking action is released.

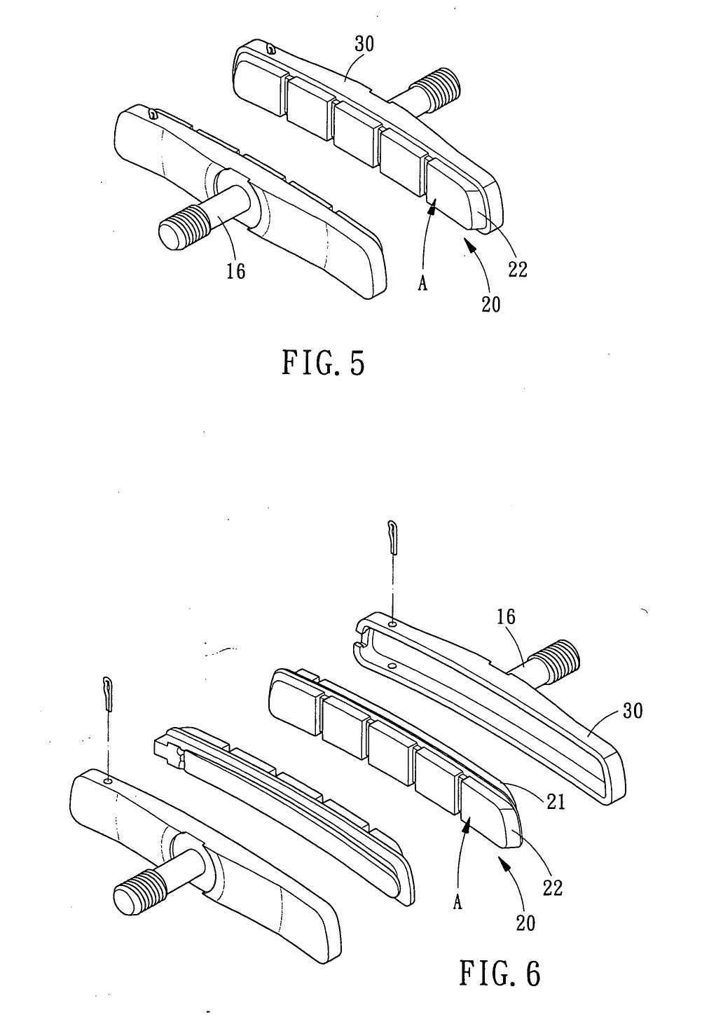

As best seen in FIGS. 4-6, each of the bicycle brake shoes 20 has an attachment portion 21 and a rim contacting portion 22 with a braking surface A. The attachment portion 21 and the rim contacting portion 22 are integrally formed as a one-piece, unitary member, and the attachment portion 21 is disposed in the metal housing 30, to a rear end of the housing 30 is connected the center post 16, and then the brake shoe holders 152 are coupled to the brake arms 151 by the center post 16 and the nut 161 in such a manner that the center post 16 inserts the pad supports 162. Thereby, the brake shoes 20 can be replaced directly from the metal housing 30 after being worn out (the brake shoes 20 and the metal housing 30 are attached together through track engagement).

The brake shoes 20 in this embodiment are formed from a polymer that is obtained by cross-linking Styrene butadiene rubber (SBR) with peroxide of adhesive (PO), and the polymer is further added with predetermined superaddition. The braking distances for bicycle brake shoes 20 of the present invention in wet conditions are substantially equal to the braking distances for the prior art bicycle brake shoes. However, the amount of rim wear for bicycle brake shoes 20 of the present invention is substantially reduced as compared to prior art bicycle brake shoes, where a substantial amount of alumina is used.

The aforementioned superaddition includes Stearic Acid, Zinc Stearate, Wax, ZnO, Barium Sulfate, Calcium Stearate, which can be added to the polymer that is obtained by cross-linking SBR with peroxide of adhesive or sulfur, as needed and/or desired, so as to adjust property of the brake shoes 20.

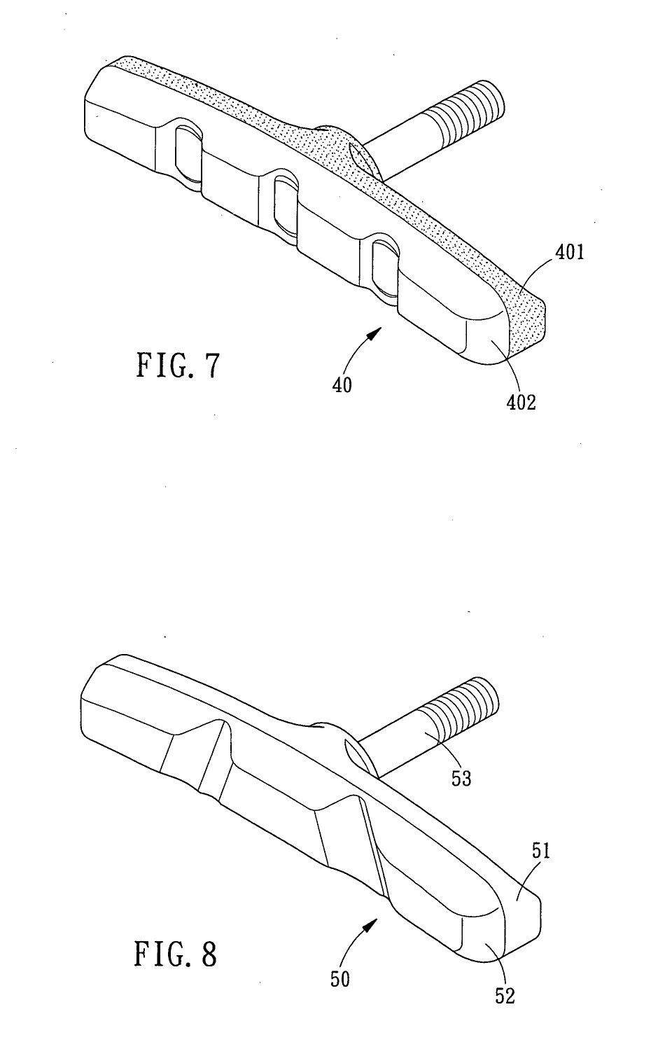

Referring now to FIG. 7, bicycle brake shoes 40 are illustrated in accordance with an alternative embodiment of the present invention. Specifically, the attachment portions 401 and the rim contacting portions 402 are formed of separate pieces that are integrally attached together by adhesive or the like. Thus, in this embodiment, the attachment portions 401 can be constructed of any other suitable material. Each of the attachment portions 401 is fixedly attached to one of the rim contacting portions 402 by a suitable means such as adhesive or the like. The attachment portions 401 are received in recesses of the brake shoe holders. Threaded fasteners or screws are utilized to fixedly secure the bicycle brake shoes to the brake shoe holders in a relatively conventional manner.

Referring to FIG. 8, the center posts 53 are embedded in the brake shoes 50, specifically, one end of each center post 53 is embedded within one of the attachment portions 51 during the molding process of the bicycle brake shoes 50. The attachment portions 51 and the rim contacting portion 52 are integrally formed as a one-piece, unitary member. In other words, while only limited manufacturing techniques are disclosed herein for constructing bicycle brake shoes in accordance with the present invention, it will be apparent to those skilled in the art from this disclosure that numerous other manufacturing techniques may be utilized in constructing bicycle brake shoes in accordance with the present invention.

In manufacturing the bicycle brake shoes, the various materials to be blended are first measured by weight to the appropriate weight percentage and then mixed together. Next, the mixture is processed in a conventional manner to form an extruded sheet of rubber. The sheet of rubber is then cut into individual sheets that are used in a conventional molding process to form a plurality of bicycle brake shoes with rim contacting portions composed of the rubber compound, as mentioned above.

During the molding process, the attachment portion and the rim contacting portion are preferably integrally formed as a one-piece, unitary member. Alternatively, the attachment portion can be formed of separate piece that is integrally attached to the rim contacting portion by adhesive or the like after molding the rim contacting portion as mentioned above. Moreover, one end of the center post can be embedded within the attachment portion and/or the rim contacting portion during the molding process mentioned above.

The bicycle brake shoes in accordance with the present invention are made from the polymer that is obtained by cross-linking SBR with peroxide of adhesive or sulfur. The wet braking distance for conventional bicycle brake shoes is very poor, while very little rim wear occurs. Accordingly, rubber brake shoes have been manufactured with alumina (Al₂O₃ in order to improve the wet braking performance, while such improved rubber brake shoes with alumina cause too much wear of soft braking surfaces in the ground and polished types of rims. The braking distances for bicycle brake shoes 20 of the present invention in wet conditions are substantially equal to the braking distances for the prior art bicycle brake shoes with alumina. However, the amount of rim wear for bicycle brake shoes 20 of the present invention is substantially reduced as compared to prior art bicycle brake shoes, where a substantial amount of alumina is used.

While we have shown and described various embodiments in accordance with the present invention, it should be clear to those skilled in the art that further embodiments may be made without departing from the scope of the present invention.

What is claimed is:

1. A bicycle brake shoe comprising an attachment portion coupled to a bicycle brake shoe holder and a rim contacting portion fixedly coupled said attachment portion, said bicycle brake shoe coupled to a bicycle braking device, said bicycle brake shoe being elongated in a rotation direction of a wheel rim;
wherein said bicycle brake shoe is formed from a polymer that is obtained by cross-linking Styrene butadiene rubber with peroxide of adhesive, and said polymer is further added with predetermined superaddition, so that said bicycle brake shoe does not excessively wear the rim while maintaining good performance in wet conditions.

2. The bicycle brake shoe as claimed in claim 1, wherein the superaddition is Stearic Acid.

3. The bicycle brake shoe as claimed in claim 1, wherein the superaddition is Zinc Stearate.

4. The bicycle brake shoe as claimed in claim 1, wherein the superaddition is Wax.

5. The bicycle brake shoe as claimed in claim 1, wherein the superaddition is ZnO.

6. The bicycle brake shoe as claimed in claim 1, wherein the superaddition is Barium Sulfate.

7. The bicycle brake shoe as claimed in claim 1, wherein the superaddition is Calcium Stearate.

8. A bicycle brake shoe comprising an attachment portion coupled to a bicycle brake shoe holder and a rim contacting portion fixedly coupled said attachment portion, said bicycle brake shoe coupled to a bicycle braking device, said bicycle brake shoe being elongated in a rotation direction of a wheel rim;
wherein said bicycle brake shoe is formed from a polymer that is obtained by cross-linking Styrene butadiene rubber with sulfur, and said polymer is further added with superaddition, so that said bicycle brake shoe does not excessively wear the rim while maintaining good performance in wet conditions.

9. The bicycle brake shoe as claimed in claim 8, wherein the superaddition is Stearic Acid.

10. The bicycle brake shoe as claimed in claim 8, wherein the superaddition is Zinc Stearate.

11. The bicycle brake shoe as claimed in claim 8, wherein the superaddition is Wax.

12. The bicycle brake shoe as claimed in claim 8, wherein the superaddition is ZnO.

13. The bicycle brake shoe as claimed in claim 8, wherein the superaddition is Barium Sulfate.

14. The bicycle brake shoe as claimed in claim 8, wherein the superaddition is Calcium Stearate.

15. The bicycle brake shoe as claimed in claim 1, wherein the attachment portion and the rim contacting portion are integrally formed as a one-piece, unitary member.

16. The bicycle brake shoe as claimed in claim 8, wherein the attachment portion and the rim contacting portion are integrally formed as a one-piece, unitary member.

17. The bicycle brake shoe as claimed in claim 1, wherein the attachment portion and the rim contacting portion are formed of separate pieces that are integrally attached together by adhesive, and one end of a center post is embedded in the bicycle brake shoe during molding process of the bicycle brake shoe.

18. The bicycle brake shoe as claimed in claim 8, wherein the attachment portion and the rim contacting portion are formed of separate pieces that are integrally attached together by adhesive, and one end of a center post is embedded in the bicycle brake shoe during molding process of the bicycle brake shoe.

19. The bicycle brake shoe as claimed in claim 1, wherein the attachment portion and the rim contacting portion are integrally formed as a one-piece, unitary member, and the attachment portion is disposed in a metal housing, to a rear end of the housing is connected a center post, and then the bicycle brake shoe is coupled to a brake arms by the center post and a nut.

20. The bicycle brake shoe as claimed in claim 8, wherein the attachment portion and the rim contacting portion are integrally formed as a one-piece, unitary member, and the attachment portion is disposed in a metal housing, to a rear end of the housing is connected a center post, and then the bicycle brake shoe is coupled to a brake arms by the center post and a nut.
